(19) United States
(12) Patent Application Publication
(10) Pub. No.: US 2009/0319406 A1
(43) Pub. Date: Dec. 24, 2009

(54) Systems and Methods for Efficient Bill Payment

(76) Inventor: Keith Sibson, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/471,813

(22) Filed: May 26, 2009

Related U.S. Application Data
(60) Provisional application No. 61/059,115, filed on Jun. 5, 2008.

(51) Int. Cl. G06Q 30/00; G06Q 20/00

(52) U.S. Cl. 705/34

(57) ABSTRACT

A method for bill payment is disclosed. In one embodiment, the method includes receiving information identifying an invoicing party, specifying an amount owed to the invoicing party; and an account identifier associated with a prepaid debit card, submitting the invoicing party identification, the amount owed to the invoicing party, and the account identifier to a service provider, and collecting a convenience fee.

### RELATED APPLICATION

This application claims the benefit of U.S. Provisional patent application Ser. No. 61/059,115 filed Jun. 5, 2008, entitled “SYSTEMS AND METHODS FOR EFFICIENT BILL PAYMENT.”

### TECHNICAL FIELD

The present disclosure relates to financial transactions, and more particularly, to a system and method for efficient bill payment.

### BACKGROUND

Consumer-based purchases and transactions at retail establishments include payment with debit cards, credit cards, check cards, prepaid debit or credit cards, and the like. Post-pay cards (e.g., a credit card) may be used to pay for goods and/or services. On the other hand, a consumer may use a prepaid card to pay for goods and/or services. Either of these cards generally includes an identifier (e.g., an account number) that provides a unique identification of the card.

To complete a sale with a post-pay card, a retail merchant may collect the card identifier and a purchase or transaction amount. The merchant may send the transaction amount (e.g., using a credit card network like VISA or MASTERCARD) to an issuing bank associated with the post-pay card, requesting payment. The amount may be deducted from the cardholder's available credit. The issuing bank may subsequently bill the customer for the transaction amount.

In contrast, prepaid cards (e.g., a debit card) include an associated account which must be loaded (e.g., money must be deposited) prior to use in a purchase transaction. When a consumer buys goods or services, the transaction amount is then deducted from the associated account. This may be accomplished, for example, using an existing banking network (e.g., Credit Card or Debit Card Network). When the prepaid card is used, the transaction amount may be routed to the appropriate destination and the value of the predetermined amount may be decremented accordingly.

Prepaid cards have gained popularity in recent years in relation to post-pay cards. In some cases, prepaid cards may be obtained without an application and/or approval process. Prepaid cards are generally not subject to the interest fees and restrictions associated with post-pay cards, but still provide the convenience of quick and easy transactions at a point of sale. In addition, this type of transaction incurs a service or convenience fee that may generate billions of dollars in revenue per year for service providers.

### SUMMARY

In accordance with one embodiment of the present disclosure, a method includes receiving information identifying an invoicing party, specifying an amount owed to the invoicing party; and an account identifier associated with a prepaid debit card, submitting the invoicing party identification, the amount owed to the invoicing party, and the account identifier to a service provider, and collecting a convenience fee.

In accordance with another embodiment of the present disclosure, a method for bill payment is disclosed. The method may include servicing a prepaid debit card, the prepaid card having an associated identification number, receiving from a retail establishment account information associated with the bill, a payment amount, and the identification number associated with the prepaid debit card, and paying a convenience fee to the retail establishment.

In accordance with a further embodiment of the present disclosure, a method includes providing to a retail establishment information relating to an invoicing party, an amount owed to the invoicing party, and account information associated with a prepaid debit card and receiving a confirmation of the bill payment from the retail establishment, the confirmation including a payment date, the account information, the payment amount, a convenience fee charge, a balance remaining on the prepaid debit card, or any combination thereof.

In another embodiment of the present disclosure, a method includes receiving from a retail establishment information relating to an invoicing party, an amount paid to the invoicing party, and account information associated with a prepaid debit card, deducting the amount paid from a balance associated with the prepaid debit card, crediting the amount paid to an account associated with the invoicing party, deducting a convenience fee from the prepaid debit card, and crediting the convenience fee to an account associated with the retail establishment.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows an example bill payment process, in accordance with embodiments of the present disclosure;

FIG. 2 shows an example process for issuing a prepaid debit card to a customer, in accordance with embodiments of the present disclosure;

FIG. 3 shows an example user interface for selecting or searching an invoicing party, in accordance with embodiments of the present disclosure;

FIG. 4 shows an example user interface for entering an amount to be paid to an invoicing party, in accordance with embodiments of the present disclosure;

FIG. 5 shows an example bill payment process, in accordance with embodiments of the present disclosure; and

FIG. 6 shows an example user interface with confirmation details, in accordance with embodiments of the present disclosure.

### DETAILED DESCRIPTION

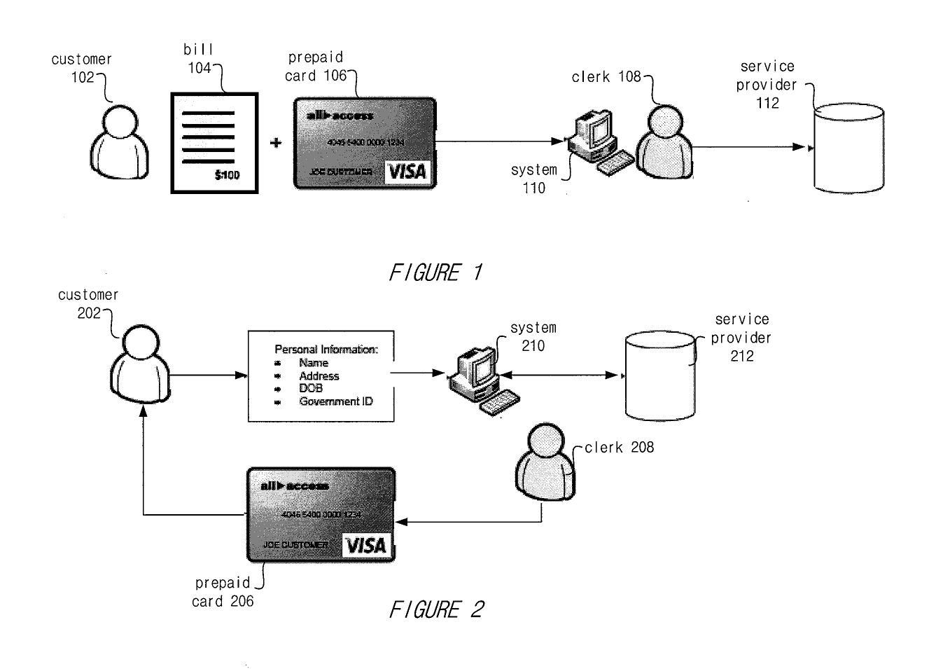

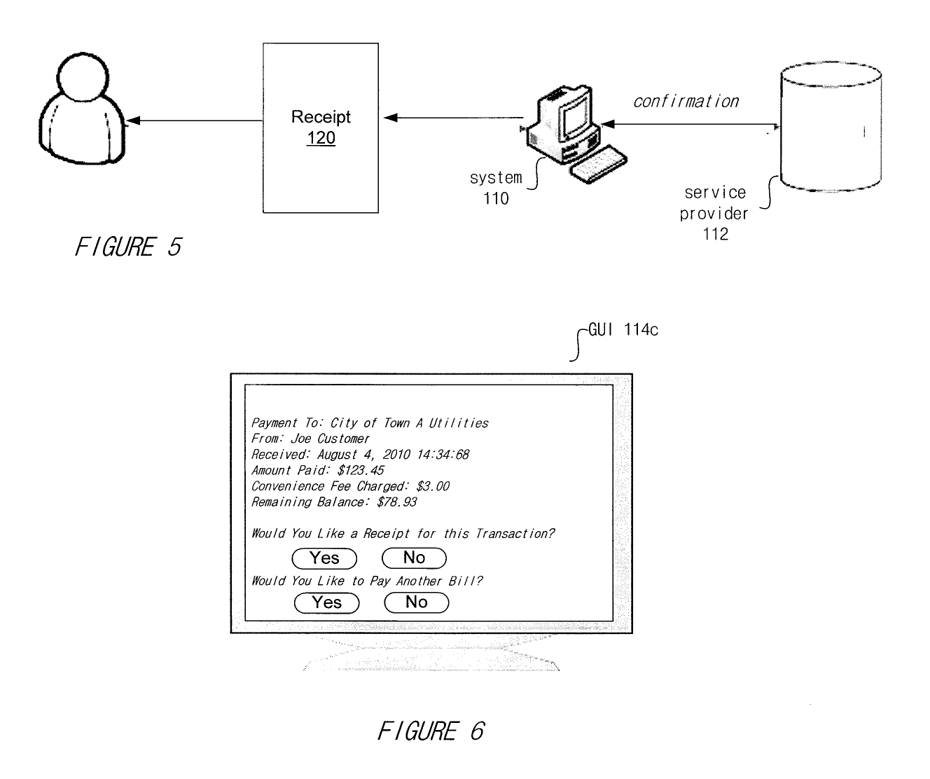

Preferred embodiments and their advantages are best understood by reference to FIGS. 1 through 6, wherein like numbers are used to indicate like and corresponding parts.

The term “service provider” as defined and used in this disclosure refers to an issuing bank or entity acting on behalf of a bank issuing a prepaid debit card. The service provider may process transactions associated with the prepaid debit card. For example, when the prepaid debit card is used, the transaction information may be routed to the service provider and the value of the predetermined amount and/or the remaining balance on the prepaid debit card may be adjusted by the service provider according to the transaction made.

Some check cashing establishments may provide walk-in payment services to their customers. These facilities may integrate their services directly with invoicing parties such as local and/or national utility companies and local and/or national cell phone service providers via known payment aggregators (e.g., CheckFreePay, MasterCard RPPS, or IPP). These solutions, however, may require substantial time and infrastructure to set up. Walk-in payment services may result in long lines of customers; further, they may offer commission structures that are small relative to check cashing fees. For both check cashing services and walk-in payment services, the retail establishment and the service provider may share any revenue generated by a service and/or a “convenience fee.” For example, for most walk-in services a small fraction of the convenience fee is retained by the retail establishment.

Tying a bill payment service to a prepaid debit card may offer several advantages. For repeat customers with bill payment history, the processing time may be greatly reduced, in some cases to a simple card swipe and confirmation click. Additionally, integrating the bill payment system with a prepaid debit card may serve as a customer acquisition channel. New customer acquisition may benefit both the retail establishment and the service provider. Traditional cash-only bill payment customers may be encouraged to obtain a prepaid debit card and then benefit from the features and services offered. The “conversion” from cash-only bill pay customer to a prepaid card customer may generate enough revenue to subsidize the walk-in payment transactions. The service providers may offer the payment service to retail establishments without charge. The service provider may allow the retail establishment to retain any service fees and/or convenience fees obtained from the bill payment system. As another example, tying the bill payment service to a prepaid debit card may avoid state and/or federal licensing requirements because the bill payment is not a cash payment. In some examples, retail establishments may avoid money transmitter licensing application fees, annual renewal fees, and/or other expenses associated with the upkeep and maintaining of records associated with cash transactions.

Teachings of the present disclosure may be used to integrate a bill payment service with a prepaid debit card. In one embodiment, a web-based point of sale solution incorporating a graphical user interface (GUI) may provide a bill payment service associated with a prepaid debit card. In another embodiment, an existing integrated service provider network may be enhanced with a bill payment extension. Prepaid cards usually include a cash loading feature, so the network and method of the present disclosure may create no additional office processing requirements. Because the settlement of the bill payment shares an existing process with loading a prepaid amount on a prepaid card, deployment of such systems may be simplified. Alternatively, for retail establishments that do not sell prepaid debit cards, the present disclosure may provide a stand-alone bill payment solution.

FIG. 1 depicts an embodiment showing a customer 102 (e.g., a repeat bill paying customer) with a previously issued prepaid debit card 106 paying a bill. Customer 102 may present prepaid debit card 106 to a clerk 108 at a retail establishment (e.g., check cashing store, grocery store, or other brick and mortar store). Customer 102 may optionally provide at least one bill 104 to clerk 108. Clerk 108 may swipe prepaid debit card 106 on a system 110 to begin the bill payment process. System 110 may include any device configured to read data from prepaid debit card 106. For example, system 110 may include a Point-of-Sale device with a magnetic stripe reader. In such examples, swiping prepaid debit card 106 may provide data to system 110 (e.g., an account number, a user ID number, etc.).

System 110 may include computer-readable media that includes any instrumentality or aggregation of instrumentalities that may retain data and/or instructions for a period of time. System 110 may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

System 110 may also be coupled to a network (not shown). The network may be implemented using hardware, software, or any combination thereof as, and may be a part of a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof. The network may transmit data (e.g., bill payment information) using wireless transmissions and/or wire-line transmissions via any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof.

Once data from prepaid debit card 106 is received by system 110, a GUI 114 may be displayed to clerk 108 and/or customer 102. GUI 114 may include any instrumentality or aggregation of instrumentalities by which either customer 102 or clerk 108 may interact with system 110. For example, GUI 114 may permit customer 102 and/or clerk 108 to input data and/or instructions into system 110 (e.g., via a keyboard, pointing device, microphone, and/or other suitable means), and/or otherwise manipulate system 110 and its associated components. GUI 114 may also permit system 110 to communicate data to clerk 108 or customer 102 by means of a display device.

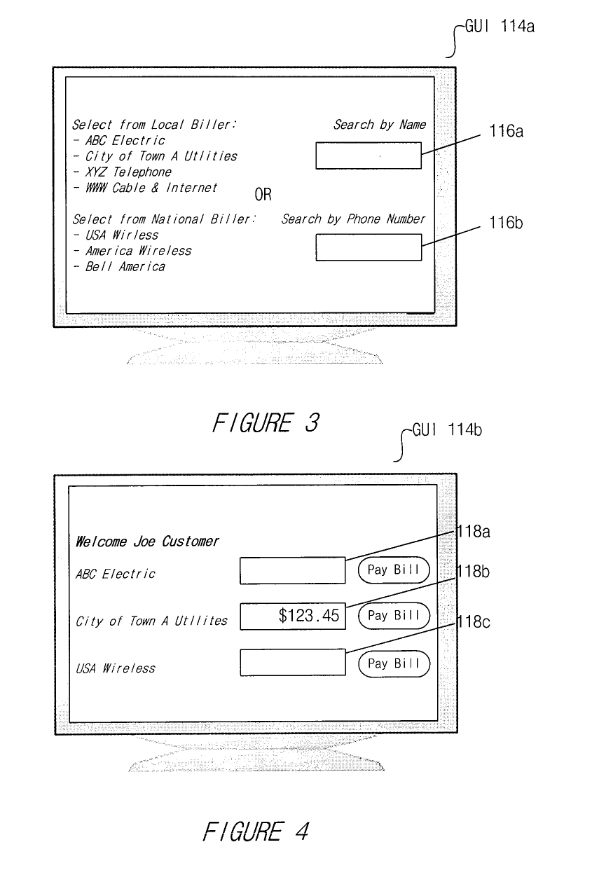

Referring to FIG. 3, GUI 114a may provide a list of local or national billers. The list may include billers that customer 102 has an account with and/or has paid bills to in the past. In addition or alternatively, the list provided may include local and national companies that provide services to a neighborhood, town, city, county, or state. GUI 114a may also include one or more searchable fields 116. For example, the customer or clerk may be able to enter the name of the invoicing party in search field 116a. As another example, the customer or clerk may enter the phone number of the invoicing party in search field 116b.

In some embodiments, upon receiving prepaid debit card data, system 110 may recognize customer 102 and may provide a more tailored GUI 116. An example is shown in FIG. 4. GUI 114b may provide one or more input fields 118a through 118c for invoicing parties who have received payments from customer 102 in the past. Customer 102 or clerk 108 may select one or more of the invoicing party shown in GUI 114b, enter the amount to be paid, and submit the one or more transactions with a click of a mouse or by touching the GUI 114.

If a transaction is completed or bill is paid, relevant information (e.g., customer name, customer account number, billing invoice number, invoicing party, amount of payment, date of payment, prepaid debit card number, or a combination of the foregoing) may be provided to a service provider 112, coupled to system 110, as shown in FIG. 1.

Service provider 112 may deduct the amount of the payment from the available funds associated with the prepaid debit card and/or may credit an account associated with the invoicing party (e.g., utility company, cell phone company, etc.). Service provider 112 may also deduct a convenience fee from the available funds of the prepaid debit card. Some or all of the convenience fee may subsequently be credited to the retail establishment's account. Alternatively, a convenience fee may be collected from cardholder 102 at the retail establishment.

Once the transaction is completed, the service provider may send a confirmation to system 110. In one embodiment, referring to FIG. 6, the confirmation may be displayed in GUI 114c and may be provided to customer 102 and/or clerk 108. The confirmation may include, but is not limited to, the invoicing party, the amount paid to the invoicing party, the time and or date of the actual payment, the convenience fee charge, the remaining balance on the prepaid debit card, or any combination of the foregoing. GUI 114c may provide a receipt 120 to be printed. As another example, GUI 114c may allow another bill payment transaction to take place.

In some embodiments, a prepaid debit card 106 may be issued to a customer 202 prior to paying a bill. Referring to FIG. 2, customer 202 may provide personal information (e.g., name, address, and date of birth) and/or may provide a government identification card to establish an account. Customer 202 may also provide cash where the cash amount is the balance loaded onto the prepaid debit card plus a service and/or convenience fee. The information provided by customer 202 and the amount to be loaded may be entered into a system 210 and may be forwarded to a service provider 212. Once the account is set up, service provider 212 may send a confirmation to system 210 and a clerk 208 may issue prepaid debit card 206 to customer 202. Customer 202 may then use prepaid debit card 206, for example using the flowchart shown in FIG. 1.

Although the present disclosure has been described in detail, it should be understood that various changes, substitutions, and alterations may be made hereto without departing from the spirit and the scope of the invention as defined by the appended claims.

What is claimed is:

1. A method comprising:
receiving information identifying an invoicing party, specifying an amount owed to the invoicing party; and an account identifier associated with a prepaid debit card;
submitting the invoicing party identification, the amount owed to the invoicing party, and the account identifier to a service provider; and
collecting a convenience fee.

2. A method according to claim 1, wherein receiving information comprises receiving the information via a user interface.

3. A method according to claim 1, wherein collecting the convenience fee comprises collecting the convenience fee in cash.

4. A method according to claim 1, wherein collecting the convenience fee comprises collecting the convenience fee from the service provider.

5. A method according to claim 1, further comprising receiving a transaction summary from the service provider.

6. A method according to claim 5, wherein the transaction summary includes an amount paid to the invoicing party and the convenience fee collected.

7. A method according to claim 1, further comprising providing a remaining balance associated with the prepaid debit card.

8. A method for bill payment comprising:
servicing a prepaid debit card, the prepaid card having an associated identification number;
receiving from a retail establishment account information associated with the bill, a payment amount, and the identification number associated with the prepaid debit card; and
remitting a convenience fee to the retail establishment.

9. A method according to claim 8, further comprising sending a confirmation of the bill payment to the retail establishment.

10. A method according to claim 8, further comprising sending a confirmation of the bill payment to the retail establishment, wherein the confirmation comprises one or more of the group consisting of: a payment date, the account information, the payment amount, the convenience fee charge, and a balance remaining on the prepaid debit card.

11. A method according to claim 8, further comprising:
deducting the amount owed and the convenience fee from a balance associated with the prepaid debit card;
crediting the amount owed to an account associated with the invoicing party; and
crediting the convenience fee to an account associated with the retail establishment.

12. A method according to claim 8, wherein paying the convenience fee comprises:
deducting the convenience fee from a balance associated with the prepaid debit card; and
crediting the convenience fee to an account associated with the retail establishment.

13. A method comprising:
providing to a retail establishment information relating to an invoicing party, an amount owed to the invoicing party, and account information associated with a prepaid debit card; and
receiving a confirmation of the bill payment from the retail establishment, the confirmation comprising a payment date, the account information, the payment amount, a convenience fee charge, a balance remaining on the prepaid debit card, or a combination thereof.

14. A method according to claim 13 further comprising paying the convenience fee charge in cash to the retail establishment.

15. A method comprising:
receiving from a retail establishment information relating to an invoicing party, an amount paid to the invoicing party, and account information associated with a prepaid debit card;
deducting the amount paid from a balance associated with the prepaid debit card;
crediting the amount paid to an account associated with the invoicing party;
deducting a convenience fee from the prepaid debit card; and
crediting the convenience fee to an account associated with the retail establishment.

16. A method according to claim 15, wherein account information associated with the prepaid debit card includes an identification number.

17. A method according to claim 15, further comprising providing a transaction summary to the retail establishment, the transaction summary including information including one or more chosen from the group comprising: a payment date, the amount paid to the invoicing party, the convenience fee paid to the retail establishment, a balance on the prepaid debit card.

18. A method according to claim 15, further comprising crediting an additional incentive fee to the account associated with the invoicing party.

19. A method according to claim 15, further comprising issuing the prepaid debit card to a user.

20. A method according to claim 19, further comprising maintaining an account associated with the prepaid debit card.
